(19) United States
(12) Patent Application Publication
(10) Pub. No.: US 2026/0290778 A1
(43) Pub. Date: Sep. 24, 2026

(54) LASER ABLATING LASER IONIZATION DEVICE AND METHOD, AND MASS SPECTROMETER

(71) Applicant: SHANGHAI CHEMLAB INSTRUMENT CO., LTD, Shanghai (CN)

(72) Inventors: Yonggang Hu, Shanghai (CN); Guorong Chen, Shanghai (CN)

(73) Assignee: SHANGHAI CHEMLAB INSTRUMENT CO., LTD, Shanghai (CN)

(21) Appl. No.: 19/476,167

(22) PCT Filed: Mar. 7, 2024
(86) PCT No.: PCT/CN2024/080433

§ 371 Date: Oct. 16, 2025

(30) Foreign Application Priority Data
May 29, 2023 (CN) 202310616711.0

(51) Int. Cl. H01J 49/16

(52) U.S. Cl. CPC H01J 49/161

(57) ABSTRACT

A laser ablation laser ionization device, comprising a laser emitter, an optical path selector, a first three-dimensional galvanometer system, a second three-dimensional galvanometer system, a first and a second field lens, wherein the light path selector is used for performing, between an ablation laser light path and an ionization laser light path, high-speed switching on a laser beam emitted by the laser emitter; the first three-dimensional galvanometer system is used for adjusting the position of a focus of the ablation laser light path; the first three-dimensional galvanometer system comprises a first mobile lens, a first focusing lens, a first X-axis galvanometer and a first Y-axis galvanometer; the second three-dimensional galvanometer system is used for adjusting the position of a focus of the ablation laser light path; and the second three-dimensional galvanometer system comprises a second mobile lens, a second focusing lens, a second Z-axis galvanometer and a second Y-axis galvanometer.

### TECHNICAL FIELD

The present invention relates to the technical field of mass spectrometry, and more particularly to a laser ablation laser ionization device and a method, and a mass spectrometer.

### Related Art

Compared with traditional solution analysis, the solid direct analysis technology has the characteristics of time-saving and labor-saving efficiency, reduces the cumbersome process of pre-processing a sample, avoids sample pollution caused by introduction of other substances such as strong acids in the pretreatment, and destroys the original state and structure of the sample, and retains information such as the spatial distribution and depth distribution of the sample components. With the gradual maturation of the laser ablation system, laser ablation is used as a solid direct injection mode, and the combined use of mass spectrometry has great advantages in trace, super trace elements, isotope analysis, etc. which not only plays an important role in the development of the technical development of the Earth Science, but also extends to the fields of material science, environmental science, marine science, life science and the like.

The laser ablation device uses a laser transmitter to emit a laser beam, uses an objective lens to focus the laser to a specific region, uses the energy of the pulsed laser to directly form tiny particles on the solid sample, forms an aerosol with the carrier gas, and then enters the mass spectrum for element detection by means of an inductively coupled plasma source (ICP). The laser ablation and mass spectrometry commonly used is a LA-ICP-MS laser ablation-inductively coupled plasma mass spectrometer and a LA-ICP-TOF-MS laser ablation-inductively coupled plasma time-of-flight mass spectrometer, etc. There are also some problems in traditional laser ablation, mainly laser only focusing on specific micro-regions of a sample for erosion, but there is a problem with the need for ultra-rapid ablation of different regions or quickly switching between different samples.

Mass spectrometry analysis requires first ionization of sample particles, while inductively coupled plasma (ICP) is the most commonly used plasma ionization apparatus for mass spectrometry analysis. The inductively coupled plasma (ICP) is mainly composed of four components: an RF working coil, a plasma, a sample feeding system and a gas path, and an ICP-MS principle diagram, as shown in FIG. 1. the plasma is formed by free electrons in an oscillating magnetic field induced by a high-frequency inductive coupling coil, and energy is transferred to the Ar molecule by means of a collision, so as to generate a temperature of approximately 10,000 k, After the sample aerosol enters, dissociation, atomization, and ionization are generated and is converted into a gaseous mixture of different particles such as molecules, atoms, positive ions, negative ions, electrons, and photons to form a special substance fourth state-plasma. The purpose of the plasma is to convert the aerosol into positively charged ions. When inductively coupled plasma (ICP) is operating, argon (used as cooling gas, auxiliary gas, and atomizing gas) is required, and other gases that may be used include hydrogen and helium, and also require a water cooling device.

Given the characteristics of inductively coupled plasma (ICP) complexity and high requirements, researchers have recently invented laser ablation laser ionization-ion flight time mass spectrometry, i.e. LALI-TOF-MS all-in-one machine, as shown in FIG. 2. In the device, a laser beam 10 is used to perform ablation on the sample 30, and the sample particles are etched to form neutral particles and plasma; the other laser beam 10 is irradiated to the inside of the etched particle neutral particles to perform laser ionization to form ions; and the generated ions enter a time-of-flight mass spectrometer (TOF) for separation, qualitative and quantitative. A laser ionization principle is used in the device, and a certain energy (laser energy) is used to destroy the atomic bond of a substance molecule, and an ionization process is generated. The advantage is that after laser ionization is used, the device becomes compact and miniaturized, but the following defects are also present:
1. laser ablation can only ablate specific micro-regions of a sample;
2. the sampling amount is low, and there is an uncertainty;
3. The laser beam cannot completely cover the etched neutral particle cloud group and cannot be automatically focused, resulting in low ionization rate.

Therefore, how to improve the sampling amount and ionization efficiency of the LALI technology, thereby improving the detection sensitivity is an urgent problem to be solved.

### SUMMARY OF THE INVENTION

In view of the above, one of the objectives of the application is to provide a laser ablation laser ionization device, comprising a laser transmitter, an optical path selector, a first three-dimensional galvanometer system, a second three-dimensional galvanometer system, a first field lens and a second field mirror;

The optical path selector is used for performing high-speed switching between the laser beam emitted by the laser transmitter and the ionization laser light path;

The first three-dimensional galvanometer system is used for adjusting the position of the focal point of the etched laser optical path;

The first three-dimensional galvanometer system comprises a first moving lens, a first focusing lens, a first X-axis galvanometer and a first Y-axis galvanometer;

The second three-dimensional galvanometer system is used for adjusting the position of the focal point of an ionizing laser optical path;

The second three-dimensional galvanometer system includes a second moving lens, a second focusing lens, a second Z-axis galvanometer, and a second Y-axis galvanometer.

Preferably, the first moving lens is axially movable along an etching laser optical path, by adjusting the distance between the first moving lens and the first focusing lens, the position of the focal point of the etching laser light path changes along the Z axis on the surface of the sample;

The second moving lens can move axially along an ionizing laser optical path, and the second moving lens changes the distance between the second moving lens and the second focusing lens by adjusting the distance between the second moving lens and the second focusing lens, so that the position of the focal point of the ionizing laser optical path changes along the X axis above the surface of the sample;

The first X-axis galvanometer and the first Y-axis galvanometer can respectively perform high-frequency winding reciprocating rotation, and the first X-axis galvanometer and the first Y-axis galvanometer are used for adjusting the position of the focal point of the etched laser optical path in the horizontal direction of the sample surface;

The second Z-axis galvanometer and the second Y-axis galvanometer can respectively perform high-frequency winding reciprocating rotation, and the second Y-axis galvanometer and the second Z-axis galvanometer are used for adjusting the position of the focal point of the ionizing laser optical path in the YZ plane direction.

Preferably, the optical path selector is an optical path switching galvanometer.

Preferably, a time consumed by the optical path selector to switch an optical path is less than 1 μs.

A laser ionization method for laser ablation, characterized in that the laser ablation laser ionization device is used;

During one laser ablation laser ionization, the optical path selector first switches to an etched laser optical path for laser ablation, then switches to an ionizing laser optical path for laser ionization in 1 μs, and the focal point of the ionized laser optical path is located above the focal point of the etched laser optical path.

Preferably, in the laser ionization process of one laser, the position of the focal point of the etched laser light path is one, the position of the focal point of the ionization laser light path comprises at least two, and the second three-dimensional galvanometer system switches the focus of the ionizing laser light path between different positions.

Preferably, during the laser ionization of one laser, the position of the focal point of the etched laser light path comprises at least two, and the first three-dimensional galvanometer system switches the focal point of the etched laser light path between different positions;

During one laser ablation laser ionization, the position of the focal point of the ionizing laser light path comprises at least two, and the second three-dimensional galvanometer system switches the focal point of the ionizing laser light path between different positions.

A laser ablation laser ionization device in LALI-MS mass spectrometry or LALI-TOF-MS mass spectrometry is applied.

Compared with the prior art, the application has the following beneficial effects:
1. laser ablation and laser ionization of the present invention use the same laser transmitter, and rotate at a high speed by means of a galvanometer, so as to achieve high-speed switching between the laser beam of the laser beam and the ionization laser light path, thereby reducing the volume and cost of the system; By means of the three-dimensional galvanometer system, the laser beam can be accurately positioned on the X axis and the Y axis, and high-speed precise focusing is achieved in the Z axis, so that the three-dimensional laser ablation of the sample is truly realized, the precision and efficiency of laser ablation are greatly improved, the focusing height is adjustable, the laser beam is suitable for uneven surface samples or layered erosion, and the ionizing laser can completely cover the neutral particle cloud after laser ablation, thereby greatly improving the efficiency of laser ionization;
2. The working condition required by the present invention is simpler (i.e. only requires a vacuum environment) compared with the working condition of the inductively coupled plasma source in the prior art, which not only greatly reduces the working condition (no carrier gas is required to greatly reduce the cost), but also greatly improves the efficiency of sample ionization, prolongs the service life of the mass spectrometry detector, the analysis device is more compact, has a high ionization efficiency, and makes elemental analysis simple. In addition, the present invention can also set related parameters such as an X\Y\Z axis by means of a computer, so that each sampling amount can be predicted and determined, greatly improving the consistency of the laser ablation sample, so as to have higher stability and measurement precision after combined with mass spectrometry, and can quickly obtain a high-quality three-dimensional elemental imaging diagram of a sample;
3. In the present invention, the plasma source is not inductively coupled, but further laser ionization is performed after etching, so that the fractionation effect in mass spectrometry analysis can be significantly reduced, no carrier gas is required, the interference of carrier gas, such as argon, on analysis is eliminated, and the ion source of the device is transmitted in a vacuum, thereby improving the sensitivity of the detection device and reducing the substrate effect;
4. The device solves the problem of sample and ionization of a solid sample, reduces the pretreatment process of the sample, avoids pollution caused in the pretreatment process of the sample, retains the in-situ information of the sample, significantly improves the reliability of solid sample analysis, and improves the accuracy of analysis and device detection sensitivity.

### DESCRIPTION OF THE DRAWINGS

In order to more clearly illustrate the technical solutions in the embodiments of the present invention or in the prior art, a brief introduction to the drawings necessary for describing the embodiments or the prior art is provided below. It is apparent that the drawings in the following description are merely some embodiments of the present invention, and for those of ordinary skill in the art, other drawings can be obtained based on these drawings without inventive effort.

FIG. 1 is a schematic diagram of the principle of ICP-MS in the prior art.

FIG. 2 is a schematic diagram of the principle of a LALI-TOF-MS integrated machine in the prior art.

FIG. 3 and FIG. 4 are schematic diagrams of a laser ablation device disclosed in Embodiment 1.

FIG. 5 is a schematic structural diagram of a first three-dimensional galvanometer system.

FIG. 6 is a schematic structural diagram of a second three-dimensional galvanometer system.

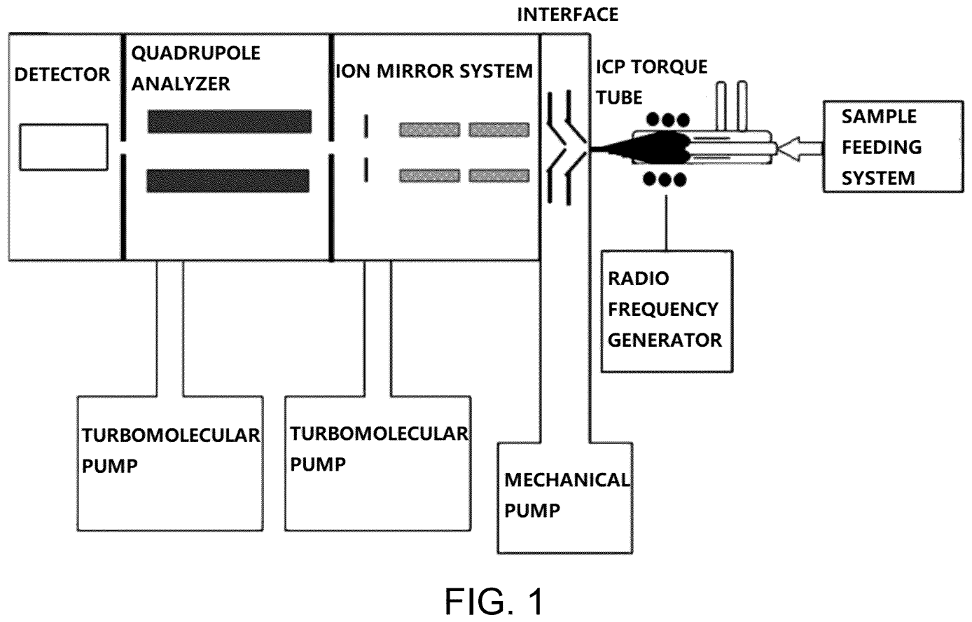

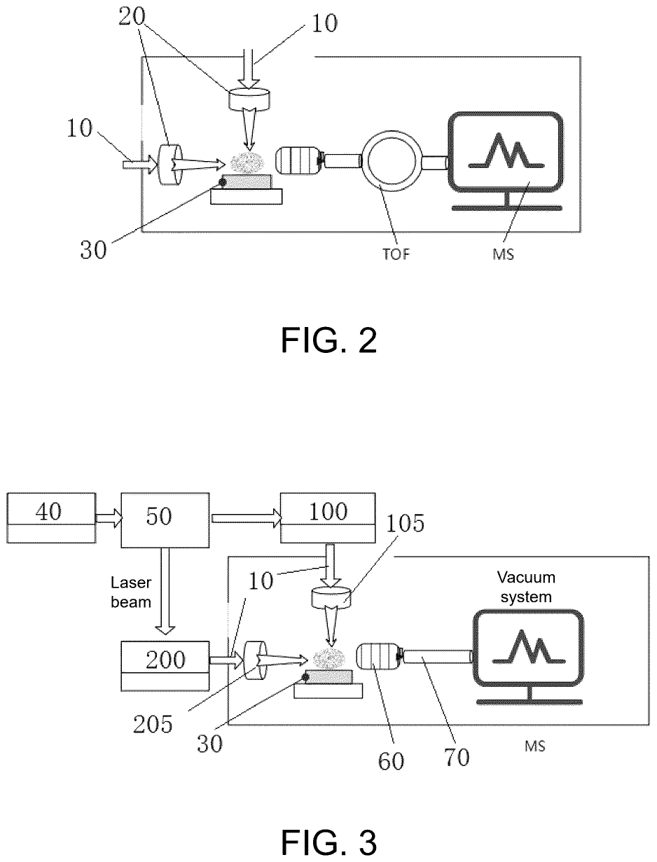

Wherein: 10. a laser beam; 20. field mirror; 30 samples; 301 neutral particle cloud; 40 laser transmitter; 50 optical path selector; 60 ion lens; 70 four-stage rod; 100 first three-dimensional galvanometer system; 101 first moving lens; 102 first focusing lens; 103 first X-axis galvanometer; 104 first Y-axis galvanometer; 105 first field mirror; 200 second three-dimensional galvanometer system; 201 second moving lens; 202 second focusing lens; 203 second Y-axis galvanometer; 204 second Z-axis galvanometer; 205 second field lens.

### DETAILED DESCRIPTION OF EMBODIMENTS

One of the cores of the present invention is to provide a laser ablation device for laser ablation. A three-dimensional galvanometer system is used as an ablation laser focusing device of LALI and an ionizing laser focusing device, so that high-speed ablation and high-speed ionization of multiple spatial points during one sampling process can be used to greatly improve the sampling amount and ionization efficiency of the LALI technology, thereby improving the detection sensitivity.

The technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

### Embodiment 1

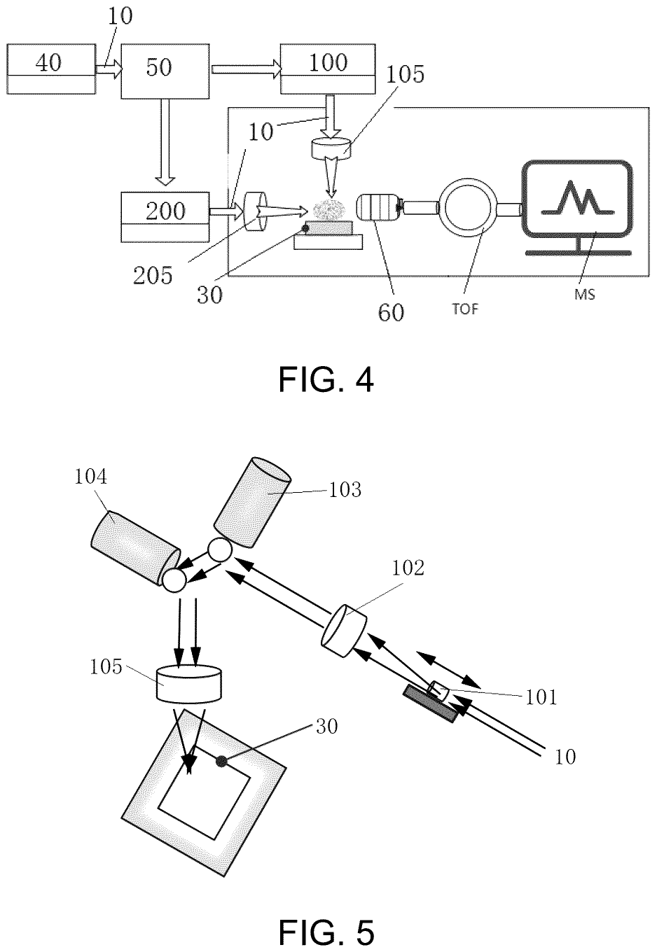

As shown in FIG. 3, the present embodiment comprises a laser transmitter 40, an optical path selector 50, a first three-dimensional galvanometer system 100, a second three-dimensional galvanometer system 200, a first field lens 105 and a second field lens 205; The first three-dimensional galvanometer system 100 is used for adjusting the position of the focal point of an etched laser optical path. The first three-dimensional galvanometer system 100 comprises a first moving lens 101, a first focusing lens 102, a first X-axis galvanometer 103, and a first Y-axis galvanometer 104. The second three-dimensional galvanometer system 200 is used for adjusting the position of the focal point of the ionizing laser light path. The second three-dimensional galvanometer system comprises a second moving lens 201, a second focusing lens 202, a second Y-axis galvanometer 203, and a second Z-axis galvanometer 204 The present embodiment also proposes a LALI-MS mass spectrum or a LALI-TOF-MS mass spectrometry using this embodiment In the device, as shown in FIG. 3 and FIG. 4, the sample 30 to be etched, the ion lens 60, the four-stage rod 70 (and/or the TOF device), and the mass spectrometer are all in a vacuum environment.

In the present embodiment, a same laser transmitter is used, an optical path switching galvanometer is used as an optical path selector 50, and a laser beam 10 emitted by the laser transmitter 40 is switched at a high speed within 1 μs between a laser light path and an ionizing laser light path.

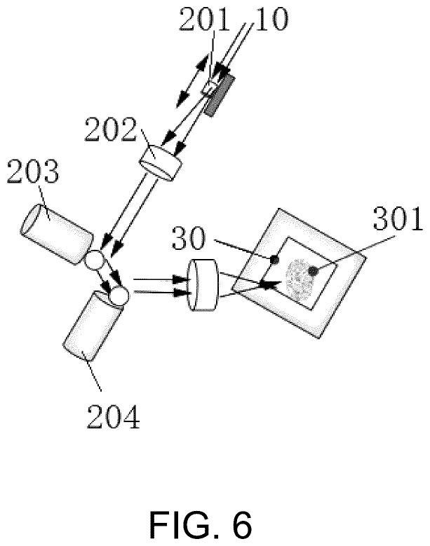

The three-dimensional galvanometer system involved in the present embodiment consists of various components as shown in FIG. 5 and FIG. 6. FIG. 5 is a schematic structural diagram of a first three-dimensional galvanometer system 100. FIG. 6 is a schematic structural diagram of a second three-dimensional galvanometer system 200. The two galvanometer lenses are arranged at right angles. When the three-dimensional galvanometer system works, the laser beam 101 first enters the moving lens, and after passing through the moving lens, the light beam is quickly dissipated, and then enters a focusing lens. By adjusting the distance between the moving lens and the focusing lens, the final focusing position of the laser beam 10 changes along the optical axis, and the adjustment of the moving lens can be controlled by means of a computer to achieve high-speed focusing. then, the laser beam 10 sequentially irradiates the two reflectors (the reflector is a galvanometer) at a certain angle of incidence, and finally, the laser beam 10 enters the field lens 20 and is focused onto the working surface. The two reflectors are respectively driven by a swing motor, and can be accurately deflected by means of a computer.

Since the optical axis of the laser optical path is perpendicular to the surface of the sample 30 during actual operation, the optical axis of the ionization laser light path is generally parallel to the surface of the sample 30 (in some other embodiments, the optical axis of the ionization laser light path can also be obliquely arranged), and the two-dimensional high-speed focusing system cannot be simultaneously applied to the cooperative focusing of the two. Therefore, in this embodiment, the three-dimensional galvanometer system is used for focusing. At this time, the X-axis may be set as the optical axis of the ionizing laser light path, then the laser light path is etched, and the galvanometer lens of the three-dimensional galvanometer system corresponding to each of the ionizing laser light paths is an X-axis galvanometer and a Y-axis galvanometer (as shown in FIG. 5, the first X-axis galvanometer 103 and the first Y-axis galvanometer 104), and the Y-axis galvanometer and the Z-axis galvanometer (as shown in FIG. 6, the second Y-axis galvanometer 203 and the second Z-axis galvanometer 204).

The three-dimensional galvanometer system of the ionizing laser light path appears consistent with the three-dimensional galvanometer system of the etched laser light path, but there is a certain difference in principle. In order to compact the device, the two optical paths use the same laser transmitter 40. In some other embodiments, two laser emitters 40 May also be used to generate laser light beams of which the laser beam 10 needs to be etched using a fundamental frequency or a quadruple frequency or five times, respectively, and the ionizing laser light path must be a four-frequency or five-frequency laser transmitter.

In actual use, the frequency, energy density, spot size, etc. of the laser beam 0 are first provided in the computer, and then the area of the sample 30 to be etched (or directly inputting the X-axis and Y-axis coordinates) and the height of the focusing point are selected. The laser transmitter 40 generates the laser beam 0 to accurately and efficiently perform three-dimensional laser ablation on the sample 30 after passing through the optical path system and the three-axis scanning galvanometer, so that a plasma and a neutral particle cloud with accurate sampling amount can be obtained. The focusing position of the ionizing laser light path is automatically generated by a computer according to a preset algorithm according to the relevant parameters of the etching position, so that higher ionization efficiency and consistency can be achieved.

The present embodiment also provides a laser ablation laser ionization method based on the above device: the laser transmitter 10 emits a laser beam 40 to enter a three-dimensional galvanometer system of an etched laser light path by means of an optical path switching galvanometer, and is focused to a selected region of a sample 30 on the surface of the sample 30 (which can be a single coordinate position, or can be switched between a plurality of coordinates, and perform laser ablation such as scanning in a range region) to form a plasma and a neutral particle cloud 301; after the etching is completed, the optical path switching galvanometer is driven by the motor in 1 μs to switch the laser beam to the three-dimensional galvanometer system of the ionization laser light path, and the neutral particle cloud is ionized by using the three-dimensional focusing laser beam to form an ion beam. On the one hand, the aerosol formed by the substance on the surface of the sample 30 will move towards the direction of the detection device of the secondary vacuum, and on the other hand diffuse around, so that the optimal focusing position of the ionizing laser is related to factors such as the degree of etching of the sample 30 and the switching time of the optical path, and is generally located in a neighborhood of a certain height above the etching position. A person skilled in the art would have been able to adjust the relevant parameters according to requirements so as to achieve the best effect. In addition, the ionization efficiency is relatively high near the focal point of the ionizing laser, and the position away from the focal point is relatively low. Therefore, for aerosol particles generated in one etching process, multiple positions of the ionizing laser in a certain spatial range can be focused, thereby greatly improving the overall ionization efficiency. After the ion beam formed after ionization is deflected by means of a quadrupole ion deflector, an ion lens 60 and a four-stage rod 70 enter a mass spectrometry ion detector for analysis so as to obtain a high-quality three-dimensional element imaging diagram (as shown in FIG. 3); after deflection by means of a quadrupole ion deflector, an ion lens 60 and a four-stage rod 70 enter a time-of-flight mass spectrometer for analysis, so that instantaneous analysis can be realized, and an ultra-high-quality full-element imaging diagram can be obtained (as shown in FIG. 4) .

The present embodiment, in addition to a sample 30 suitable for a flat surface, is further applicable to a sample of an uneven surface and an irregular sample 30, greatly improving the efficiency of laser ablation, achieving accurate control of the sampling amount of a sample 30, and simultaneously replacing a traditional inductively coupled plasma source ICP ionization technology with a three-dimensional focused laser ionization technique, improving ionization efficiency, and being combined with mass spectrometry to obtain a higher-quality three-dimensional elemental imaging diagram; In addition, since there is no inductively coupled plasma source in the present embodiment, and further laser ionization is performed after etching, the fractionation effect in mass spectrometry analysis can be significantly reduced, no carrier gas is required, the interference of carrier gas such as argon to analysis is eliminated, and the ion source of the device is transmitted in vacuum, thereby improving the sensitivity of the detection device and reducing the substrate effect.

The embodiments in the present specification are described in a progressive manner, each embodiment focuses on the differences from other embodiments, and the same and similar parts between the various embodiments can be referred to each other.

The above description of the disclosed embodiments enables those skilled in the art to implement or use the present application. Various modifications to these embodiments will be readily apparent to those skilled in the art, and the general principles defined herein May be implemented in other embodiments without departing from the spirit or scope of the present application. Thus, the present application is not to be limited to the embodiments shown herein, but is to be accorded the widest scope consistent with the principles and novel features disclosed herein.

1. A laser ablation laser ionization device, comprising a laser transmitter, an optical path selector, a first three-dimensional galvanometer system, a second three-dimensional galvanometer system, a first field lens and a second field mirror;
The optical path selector is used for performing high-speed switching between the laser beam emitted by the laser transmitter and the ionization laser light path;
The first three-dimensional galvanometer system is used for adjusting the position of the focal point of the etched laser optical path;
The first three-dimensional galvanometer system comprises a first moving lens, a first focusing lens, a first X-axis galvanometer and a first Y-axis galvanometer;
The second three-dimensional galvanometer system is used for adjusting the position of the focal point of an ionizing laser optical path;
The second three-dimensional galvanometer system includes a second moving lens, a second focusing lens, a second Z-axis galvanometer, and a second Y-axis galvanometer.

2. The laser ablation laser ionization device for laser ablation of claim 1, wherein the first moving lens is axially movable along an etching laser optical path, by adjusting the distance between the first moving lens and the first focusing lens, the position of the focal point of the etching laser light path changes along the Z axis on the surface of the sample;
the second moving lens can move axially along an ionizing laser optical path, and the second moving lens changes the distance between the second moving lens and the second focusing lens by adjusting the distance between the second moving lens and the second focusing lens, so that the position of the focal point of the ionizing laser optical path changes along the X axis above the surface of the sample;
the first X-axis galvanometer and the first Y-axis galvanometer can respectively perform high-frequency winding reciprocating rotation, and the first X-axis galvanometer and the first Y-axis galvanometer are used for adjusting the position of the focal point of the etched laser optical path in the horizontal direction of the sample surface;
the second Z-axis galvanometer and the second Y-axis galvanometer can respectively perform high-frequency winding reciprocating rotation, and the second Y-axis galvanometer and the second Z-axis galvanometer are used for adjusting the position of the focal point of the ionizing laser optical path in the YZ plane direction.

3. The laser ablation laser ionization device of claim 1, wherein the optical path selector is an optical path switching galvanometer.

4. The laser ablation laser ionization device of claim 1, wherein a time consumed by the optical path selector to switch an optical path is less than 1 μs.

5. A laser ablation laser ionization method, wherein the laser ablation laser ionization device according to claim 1 is used;
during one laser ablation laser ionization, the optical path selector first switches to an etched laser optical path for laser ablation, then switches to an ionizing laser optical path for laser ionization in 1 μs, and the focal point of the ionized laser optical path is located above the focal point of the etched laser optical path.

6. The laser ablation laser ionization device of claim 5, wherein in the laser ionization process of one laser, the position of the focal point of the etched laser light path is one, the position of the focal point of the ionization laser light path comprises at least two, and the second three-dimensional galvanometer system switches the focus of the ionizing laser light path between different positions.

7. The laser ablation laser ionization device of claim 5, wherein during the laser ionization of one laser, the position of the focal point of the etched laser light path comprises at least two, and the first three-dimensional galvanometer system switches the focal point of the etched laser light path between different positions;
during one laser ablation laser ionization, the position of the focal point of the ionizing laser light path comprises at least two, and the second three-dimensional galvanometer system switches the focal point of the ionizing laser light path between different positions.

8. A laser ablation laser ionization device according to claim 1 in LALI-MS mass spectrometry or LALI-TOF-MS mass spectrometry is applied.
